(19) United States
(12) Patent Application Publication
(10) Pub. No.: US 2022/0300692 A1
(43) Pub. Date: Sep. 22, 2022

(54) AI-BASED FLOORPLANNING FOR PRINTED CIRCUIT BOARD DESIGN

(71) Applicant: Intel Corporation, Santa Clara, CA (US)

(72) Inventors: Jin Yan, Santa Clara, CA (US); Adam Norman, Forest Grove, OR (US); Min Suet Lim, Gelugor (MY); Mackenzie Norman, Portland, OR (US); Hong Cheah Ho, Bukit Mertajam (MY); Jianfang Zhu, Portland, OR (US); Miaomiao Ma, Sunnyvale, CA (US)

(21) Appl. No.: 17/835,323

(22) Filed: Jun. 8, 2022

(51) Int. Cl. G06F 30/392; G06F 30/398

(52) U.S. Cl. CPC G06F 30/392; G06F 30/398

(57) ABSTRACT

Systems, apparatuses and methods may provide for technology that identifies a plurality of functional blocks in a circuit, wherein each functional block includes a plurality of components, conducts one or more passes of a first optimization loop to determine candidate aspect ratios for the functional blocks based on size data associated with the components, and conducts, within the one or more passes of the first optimization loop, one or more passes of a second optimization loop to determine candidate floorplan data for the circuit based on the candidate aspect ratios.

### TECHNICAL FIELD

Embodiments generally relate to the design of printed circuit board (PCB) layouts (e.g., “floorplans”). More particularly, embodiments relate to artificial intelligence (AI) based floorplanning for PCB design.

### BACKGROUND OF THE DISCLOSURE

A PCB may include several components of varying shapes, wherein the placement and orientation of the components on the PCB is typically determined manually. Such an approach may be time consuming and often results in suboptimal surface area usage on the PCB.

### BRIEF DESCRIPTION OF THE DRAWINGS

The various advantages of the embodiments will become apparent to one skilled in the art by reading the following specification and appended claims, and by referencing the following drawings, in which:

FIG. 1 is an illustration of an example of a plurality of functional blocks in a circuit according to an embodiment;

FIG. 2 is an illustration of an example of multiple floorplan options for a functional block of a circuit according to an embodiment;

FIG. 3 is an illustration of an example of a mathematical representation of a functional block according to an embodiment;

FIG. 4 is an illustration of an example of a floorplan and a B*-Tree representation of the floorplan according to an embodiment;

FIG. 5 is a flowchart of an example of a method of conducting AI-based floorplanning according to an embodiment;

FIG. 6 is a flowchart of an example of a more detailed method of conducting AI-based floorplanning according to an embodiment;

FIG. 7 is a plot of an example of minimal board area versus the number of Bayesian optimization iterations according to an embodiment;

FIG. 8 is a block diagram of an example of a performance-enhanced computing system according to an embodiment;

FIG. 9 is an illustration of an example of a semiconductor package apparatus according to an embodiment;

FIG. 10 is a block diagram of an example of a processor according to an embodiment; and

FIG. 11 is a block diagram of an example of a multi-processor based computing system according to an embodiment.

### DETAILED DESCRIPTION

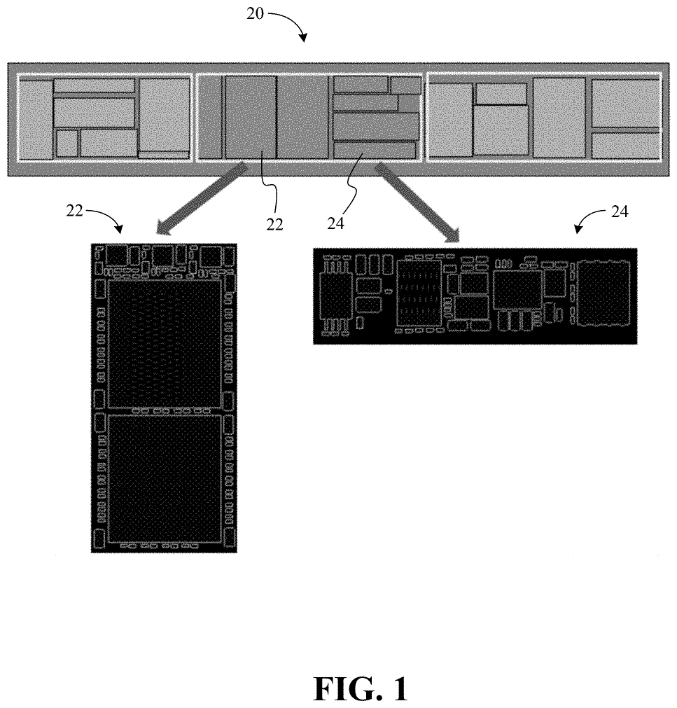

FIG. 1 shows a circuit 20 (e.g., PCB) that includes a plurality of functional blocks such as, for example, a first functional block 22 and a second functional block 24, wherein each of the functional blocks 22, 24 includes multiple components to perform various operations for the circuit 20. For example, the first functional block 22 might include a first plurality of components to perform memory operations, whereas the second functional block 24 may include a second plurality of components to perform power management operations. The illustrated circuit 20 also includes other functional blocks to perform additional operations such as, for example, wireless communication, voltage conversion, sensing, embedded controller operations, system on chip (SoC) operations, battery charging, solid state drive (SSD) operations, audio operations, input/output (IO) operations, and so forth.

As will be discussed in greater detail, AI-based technology described herein automatically determines the aspect ratios of the functional blocks 22, 24 and the layout/floorplan of the functional blocks 22, 24 within the circuit 20. More particularly, assuming there are N functional blocks and the i^{th} block includes Mᵢ rectangle components, the technology described herein determines the best location and shape of each functional block so that all of the functional blocks fit into a board outline of minimal area. Accordingly, the AI-based technology provides for faster floorplanning and reduced surface area usage on the PCB.

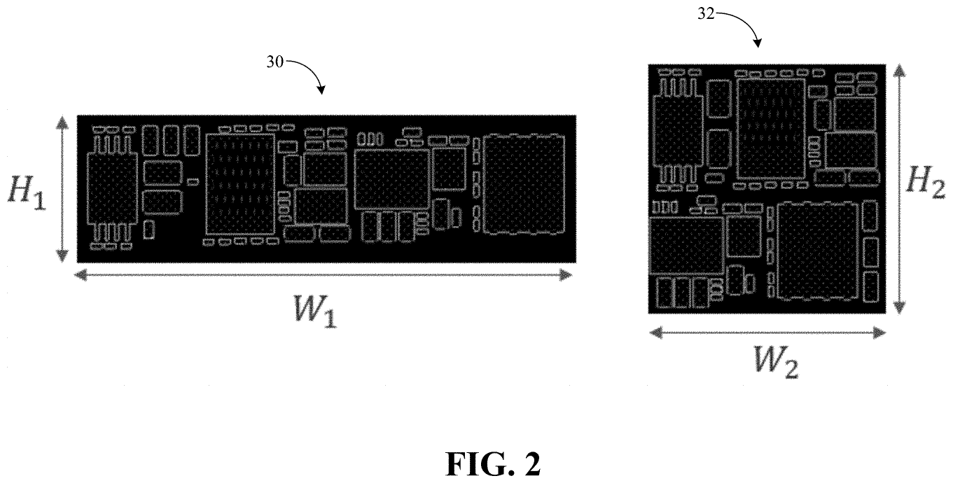

Turning now to FIG. 2, a first option 30 and a second option 32 are shown for a floorplan of a functional block such as, for example, the second functional block 24 (FIG. 1), already discussed. To simplify the problem, the outline of each functional block may be limited to being a rectangle. Since each functional block includes a list of rectangle components of various sizes, there can be many different ways to place the components.

Rather than attempting to enumerate all possible options 30, 32 for each functional block, the area to place the components for each functional block can be estimated. Assuming that the i^{th} block includes Mᵢ rectangle components, the size of each component is wᵢ^{j}×hᵢ^{j}, (j=1, 2, . . . , Mᵢ), and the spacing between two components is at least d, the area of the i^{th} rectangle block can be estimated to be:

Aᵢ=αΣⱼ₌₁^{M}^{ᵢ}(wᵢ^{j}+d)×(hᵢ^{j}+d)=Wᵢ×Hᵢ (1)

Given that the components are of various sizes, a scaling factor α is introduced to control the amount of space that is “wasted” in the block. In one example, the value of α is between 1.1 and 1.3, depending on the market segment and PCB technology. To find an accurate α for a new product, the PCB boards for past products may be analyzed to determine the α for the functional blocks on the past PCB boards, wherein the average α can be an accurate α for the current circuit.

Once the area of each functional block is determined, the size of the functional block can be controlled using an aspect ratio

$${r}_{i} = \frac{{W}_{i}}{{H}_{i}} .$$

Therefore, the area Aᵢ=Wᵢ×Hᵢ=rᵢHᵢ². The minimum value of rᵢ is 1 when the block is a square. The maximum value of rᵢ is determined by the largest component in the functional block. In that case, Hᵢ=max(hᵢ^{j}), then

$$max ( {r}_{i} ) = \frac{{A}_{i}}{{max ( {h}_{i}^{j} )}^{2}} .$$

Accordingly, the range of the aspect ratio of the i^{th} block is:

$$1 \leq r \leq \frac{{A}_{i}}{{max ( {h}_{i}^{j} )}^{2}} , ( j = 1 , 2 , … , {M}_{i} ) \qquad ( 2 )$$

To determine a floorplan, both the shape and the location of each functional block is determined. Based on the aforementioned approach, the block shape is controlled by the aspect ratio rᵢ.

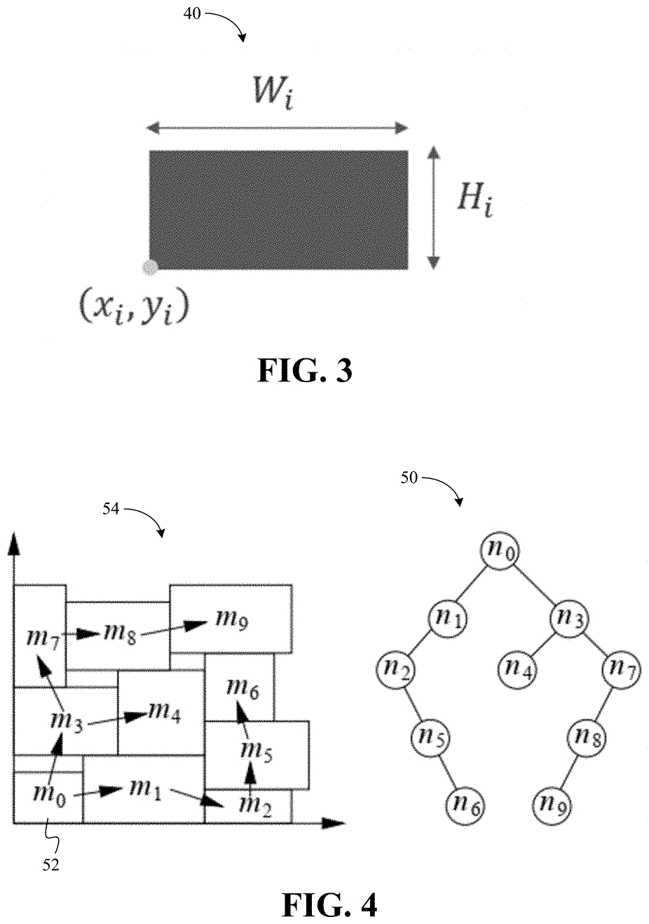

FIG. 3 demonstrates that the location of a functional block 40 can be represented by the coordinate (xᵢ, yᵢ) of the lower-left corner vertex of the functional block 40. When designing a floorplan, one constraint to satisfy is that the functional blocks do not overlap. Thus, the coordinate (xᵢ, yᵢ) is not treated as an independent variable during optimization. In an embodiment, a mathematical representation of the floorplan is used that can satisfy this non-overlapping constraint by construction.

Turning now to FIG. 4, in VLSI (very large scale integration) design, there are many different ways to represent a floorplan. One effective way is to use a B*-Tree 50. The root of the B*-Tree 50 is an m₀ functional block 52 on the bottom-left corner of a floorplan 54. If node nⱼ is the left child of node nᵢ, block mⱼ is located on the right-hand side and adjacent to module mᵢ in the floorplan 54 (e.g., xⱼ=xᵢ+wᵢ). Additionally, if node nⱼ is the right child of nᵢ, module mⱼ is located above and adjacent to module mᵢ, with the x-coordinate of mⱼ equal to that of m₁ (e.g., xⱼ=xᵢ). As long as the B*-Tree 50 representation of the floorplan 54 is known, the coordinate (xᵢ, yᵢ) of the lower-left corner of each functional block in the floorplan 54 can be determined by conducting a tree traversal.

In an embodiment, the shape of each functional block is governed by the aspect ratio rᵢ, and the geometric relationship of all functional blocks is governed by the B*-Tree 50. The optimization problem therefore becomes finding the optimal rᵢ and the optimal B*-Tree 50 that results in the smallest board area. To solve this optimization problem, AI-based technology described herein automatically finds the best floorplan 54 with minimal board area. In one example, the technology involves a two-level optimization:

1) Use Bayesian Optimization to optimize aspect ratio rᵢ of each functional block; and

2) For each aspect ratio proposed in operation 1), simulated annealing optimization is used to find the best floorplan 54 with the minimal board area.

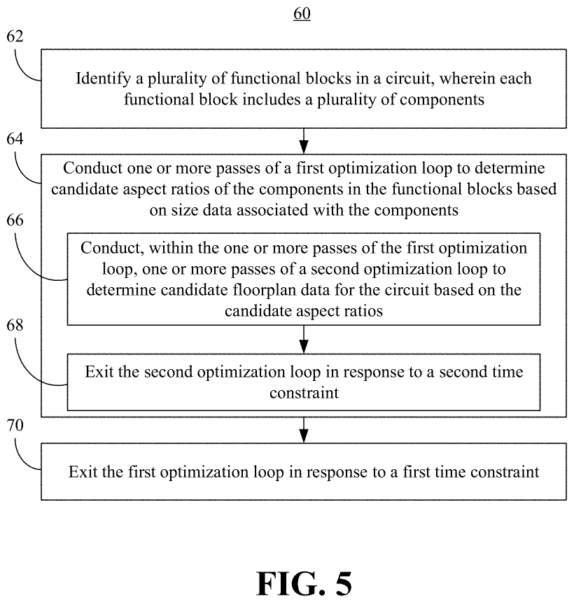

FIG. 5 shows a method 60 of conducting AI-based floorplanning. The method 60 may be implemented in one or more modules as a set of logic instructions stored in a machine- or computer-readable storage medium such as random access memory (RAM), read only memory (ROM), programmable ROM (PROM), firmware, flash memory, etc., in hardware, or any combination thereof. For example, hardware implementations may include configurable logic, fixed-functionality logic, or any combination thereof. Examples of configurable logic include suitably configured programmable logic arrays (PLAs), field programmable gate arrays (FPGAs), complex programmable logic devices (CPLDs), and general purpose microprocessors. Examples of fixed-functionality logic include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Computer program code to carry out operations shown in the method 60 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Illustrated processing block 62 provides for identifying a plurality of functional blocks in a circuit, wherein each functional block includes a plurality of components. In one example, processing block 62 involves identifying size data associated with the components. Processing block 64 conducts one or more passes (e.g., iterations, repeats) of a first optimization loop to determine candidate aspect ratios of the components in the functional blocks based on the size data associated with the components. In an embodiment, processing block 64 also determines the range of aspect ratios for each functional block. The first optimization loop may include a Bayesian optimization update of a surrogate model of the circuit based on the candidate floorplan data.

More particularly, to find the global minimal board area (e.g., objective function) given N modules with certain aspect ratio ranges and no explicit objective function for the problem, a “black box” approach may be used. Bayesian optimization is a sequential design strategy for global optimization of black box functions that does not assume any functional forms. The Bayesian strategy is to treat the minimal area problem as a random function and place a “prior” over the function, wherein the prior captures beliefs about the behavior of the function. After gathering the function evaluations (e.g., after a few iterations, area data for some aspect ratios is obtained), which are treated as data, the prior is updated to form the posterior distribution over the objective function. The posterior distribution, in turn, is used to construct an acquisition function (e.g., “infill sampling criteria”) that determines the next query point, which is the next aspect ratio to test and gather data.

With regard to the surrogate model, Bayesian optimization approaches this finding global minimal area task through a method known as surrogate optimization. A surrogate function is an approximation of the objective function. The surrogate function is formed based on sampled points. Based on the surrogate function, processing block 64 can identify which points are promising minima. More sampling is conducted from these promising regions and the surrogate function is updated accordingly. Thus, the surrogate model may be the interior model used by Bayesian optimization.

Illustrated processing block 66 conducts, within the one or more passes of the first optimization loop, one or more passes of a second optimization loop to determine candidate floorplan data for the circuit based on the candidate aspect ratios. In one example, the second optimization loop includes a simulated annealing optimization with respect to a B*-Tree representation of the candidate floorplan data. Additionally, the simulated annealing optimization may include a plurality of random perturbation operations such as, for example, rotating a functional block randomly selected from all functional blocks, moving a randomly selected functional block to another randomly selected location, swapping two randomly selected functional blocks, and so forth. Processing block 68 exits the second optimization in response to a second time constraint (e.g., time budget). In an embodiment, processing block 70 exits the first optimization loop in response to a first time constraint. Block 70 may also include automatically outputting the floorplan associated with the smallest surface area. The method 60 therefore enhances performance at least to the extent that automating the nested optimization loops saves time and/or reduces surface area usage on the PCB.

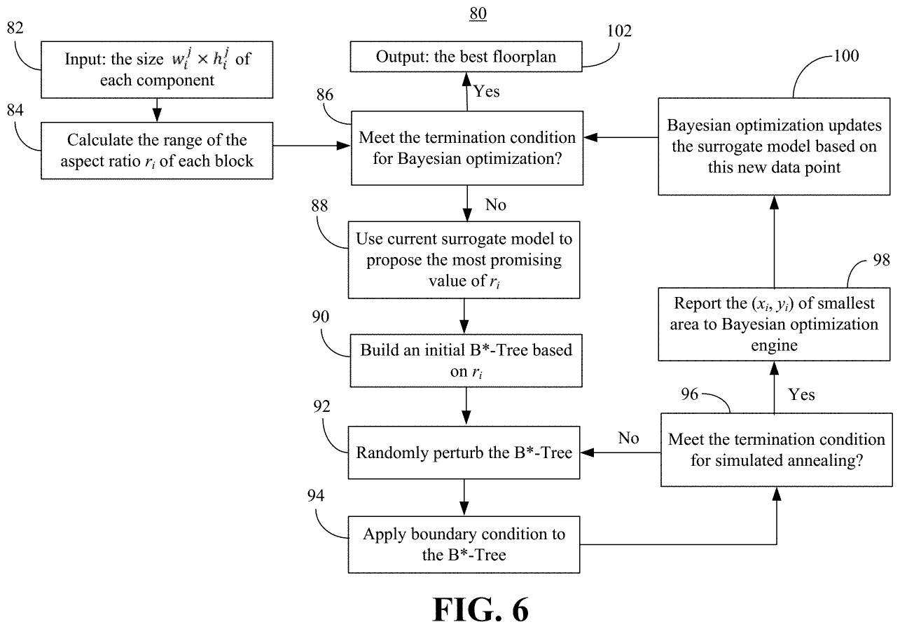

FIG. 6 shows a more detailed method 80 of conducting AI-based floorplanning. The method 80 may be implemented in one or more modules as a set of logic instructions stored in a machine- or computer-readable storage medium RAM, ROM, PROM, firmware, flash memory, etc., in hardware, or any combination thereof. For example, hardware implementations may include configurable logic, fixed-functionality logic, or any combination thereof. Examples of configurable logic include suitably configured PLAs, FPGAs, CPLDs, and general purpose microprocessors. Examples of fixed-functionality logic include suitably configured ASICs, combinational logic circuits, and sequential logic circuits. The configurable or fixed-functionality logic can be implemented with CMOS logic circuits, TTL logic circuits, or other circuits.

In general, the method 80 involves two optimization loops. The outer loop is used by Bayesian Optimization to optimize the aspect ratio, while the inner loop is used by simulated annealing to optimize the location of each functional block. Simulated annealing relies on random perturbation to generate new B*-Tree. As already noted, the random operations might include:

Rotating a functional block randomly selected from all functional blocks;

Moving a randomly selected functional block to another randomly selected location; and

Swapping two randomly selected functional blocks.

A time budget may be set for both the Bayesian optimization (BO) and the simulated annealing. When the iterative optimization loop exceeds the time budget, the optimization loop is exited. Since simulated annealing is a probabilistic technique to approximate a global optimum of a given function, a time budget of, for example, 30 seconds (s) may be set to finish one optimization loop. Therefore, Bayesian optimization is used in the outer loop to improve data efficiency. Once the Bayesian optimization time budget is met, the method 80 will output the best floorplan.

More particularly, illustrated processing block 82 identifies the size of each component in a circuit as an input. Processing block 84 calculates the range of the aspect ratio of each functional block. A determination may be made at processing block 86 as to whether the termination condition (e.g., time budget, all combinations have been attempted) for the Bayesian optimization has been met. If not, processing block 88 uses the current surrogate model of the floorplan to propose the most promising value of the aspect ratios (e.g., candidate aspect ratios). In an embodiment, processing block 90 builds an initial B*-Tree based on the candidate aspect ratios. Processing block 90 may also enforce relative position conditions such as, for example, ensuring that an instruction set architecture (ISA) functional block is next to a power management block. Illustrated processing block 92 randomly perturbs the B*-Tree (e.g., rotating a functional block randomly selected from all functional blocks, moving a randomly selected functional block to another randomly selected location, swapping two randomly selected functional blocks, etc.).

In one example, processing block 94 applies a boundary condition to the B*-Tree. Additionally, a determination may be made at processing block 96 as to whether the termination condition (e.g., time budget) for simulated annealing has been met. If not, the method 80 returns to processing block 92 and another pass of the simulated annealing optimization loop is conducted. Otherwise, processing block 98 reports the lower-left corner vertex coordinate corresponding to the floorplan with the smallest area. Processing block 100 updates the surrogate model of the floorplan with the lower-left corner vertex coordinate reported by processing block 98. In one example, the method 80 then returns to processing block 86. Once the termination condition for the Bayesian optimization is met, processing block 100 outputs the best floorplan.

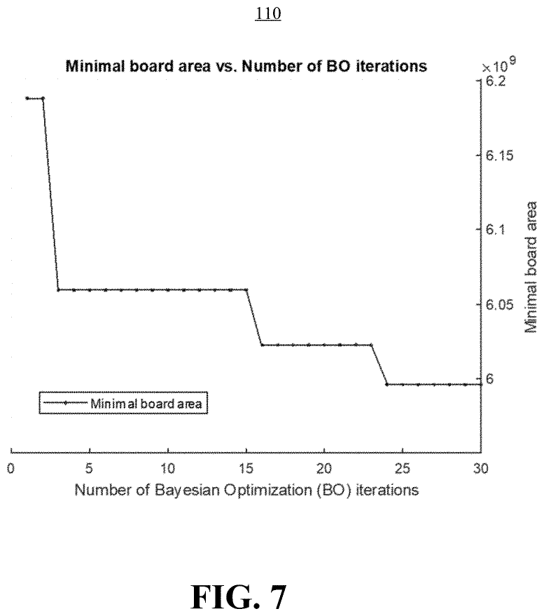

FIG. 7 shows a plot 110 of minimal board area versus the number of Bayesian optimization iterations according to the technology described herein. In the illustrated example, the minimal board area reduces as the number of Bayesian Optimization iterations increases. Indeed, it only takes 30 iterations to find a suitable floorplan, which takes about 20 minutes (mins) to run. Compared to manual placement, the technology described herein can reduce the floorplanning time from hours to 20 mins.

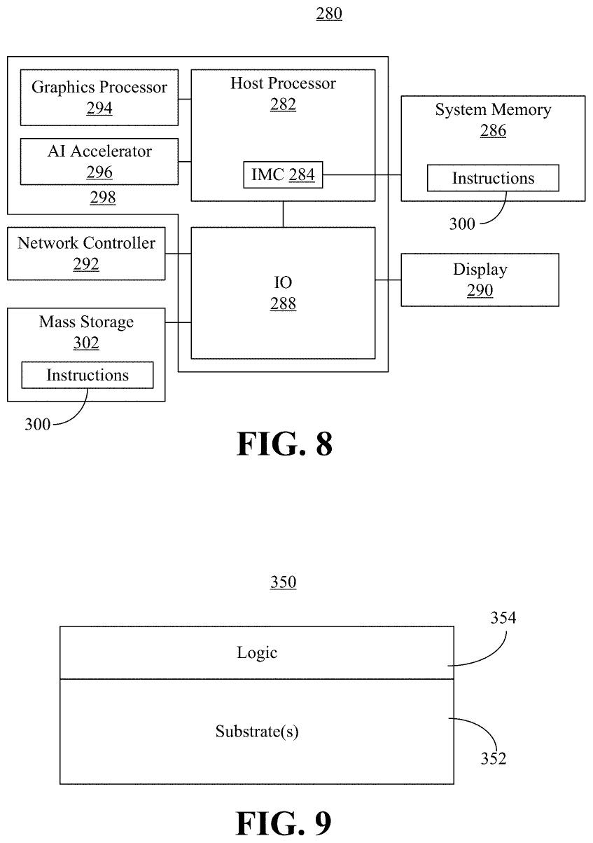

Turning now to FIG. 8, a performance-enhanced computing system 280 is shown. The system 280 may generally be part of an electronic device/platform having computing functionality (e.g., personal digital assistant/PDA, notebook computer, tablet computer, convertible tablet, server), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., CPU) having an integrated memory controller (IMC) 284 that is coupled to a system memory 286 (e.g., dual inline memory module/DIMM). In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the IO module 288, a graphics processor 294, and an AI accelerator 296 into a system on chip (SoC) 298.

In an embodiment, the host processor 282 and/or the AI accelerator 296 executes a set of program instructions 300 retrieved from the mass storage 302 and/or the system memory 286 to perform one or more aspects of the method 60 (FIG. 5) and/or the method 80 (FIG. 6), already discussed. Thus, execution of the illustrated instructions 300 by the host processor 282 and/or the AI accelerator 296 causes the host processor 282 and/or the AI accelerator 296 to identify a plurality of functional blocks in a circuit, wherein each functional block includes a plurality of components and conduct one or more passes of a first optimization loop (e.g., Bayesian optimization) to determine candidate aspect ratios for the functional blocks based on size data associated with the components. Execution of the instructions 300 by the host processor 282 and/or the AI accelerator 296 may also cause the host processor 282 and/or the AI accelerator 296 to conduct, within the pass(es) of the first optimization loop, one or more passes of a second optimization loop (e.g., simulated annealing optimization) to determine candidate floorplan data for the circuit based on the candidate aspect ratios. The candidate floorplan data may include, for example, the coordinate of the lower-left corner of each functional block in one or more candidate floorplans. The computing system 280 is therefore considered performance-enhanced at least to the extent that automating the nested optimization loops saves time and/or reduces surface area usage on the PCB.

FIG. 9 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of the method 60 (FIG. 5) and/or the method 80 (FIG. 6).

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

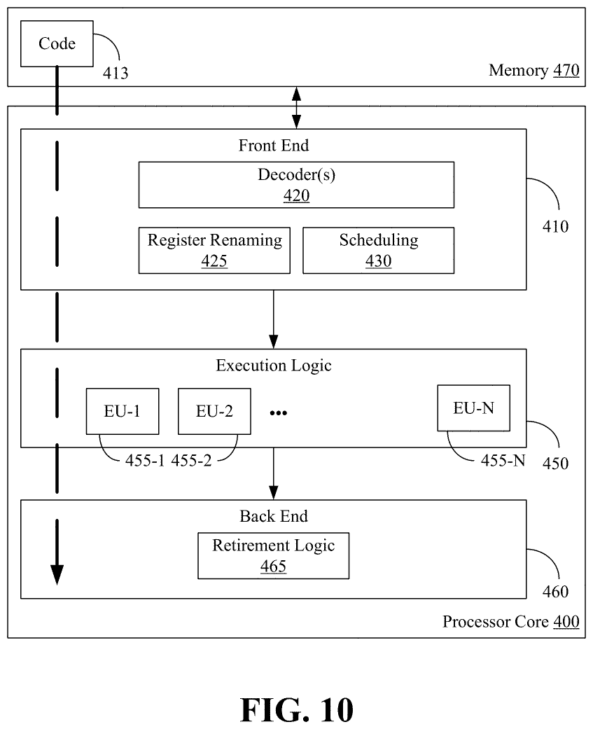

FIG. 10 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 10, a processing element may alternatively include more than one of the processor core 400 illustrated in FIG. 10. The processor core 400 may be a single-threaded core or, for at least one embodiment, the processor core 400 may be multithreaded in that it may include more than one hardware thread context (or “logical processor”) per core.

FIG. 10 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 60 (FIG. 5) and/or the method 80 (FIG. 6), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 10, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

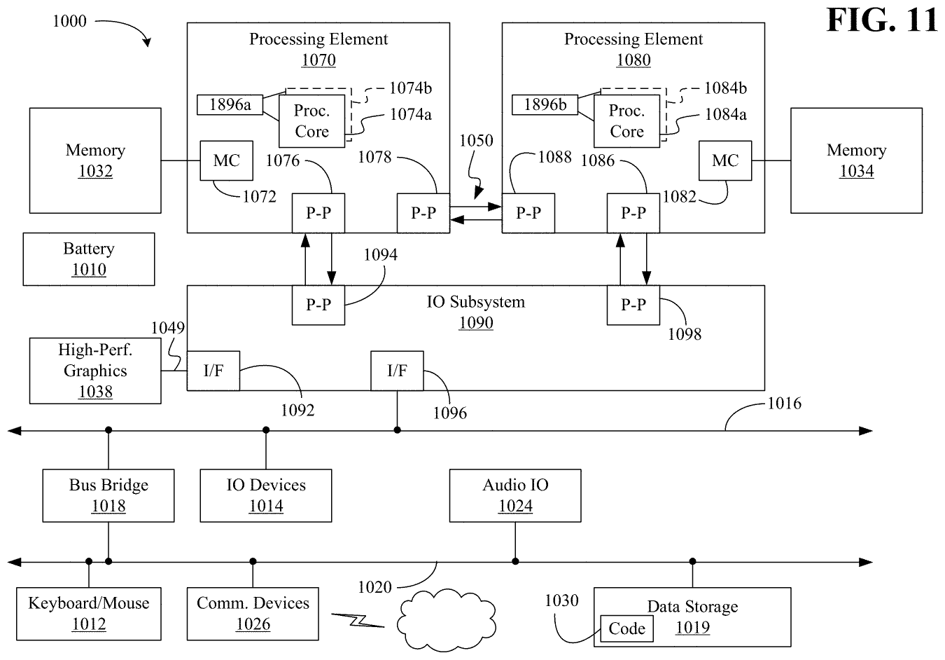

Referring now to FIG. 11, shown is a block diagram of a computing system 1000 embodiment in accordance with an embodiment. Shown in FIG. 11 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 11 may be implemented as a multi-drop bus rather than point-to-point interconnect.

As shown in FIG. 11, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 10.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 11, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 11, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 11, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 60 (FIG. 5) and/or the method 80 (FIG. 6), already discussed. Further, an audio I/O 1024 may be coupled to second bus 1020 and a battery 1010 may supply power to the computing system 1000.

Note that other embodiments are contemplated. For example, instead of the point-to-point architecture of FIG. 11, a system may implement a multi-drop bus or another such communication topology. Also, the elements of FIG. 11 may alternatively be partitioned using more or fewer integrated chips than shown in FIG. 11.

### ADDITIONAL NOTES AND EXAMPLES

Example 1 includes a performance-enhanced computing system comprising a network controller, a processor coupled to the network controller, and a memory coupled to the processor, the memory including a set of instructions, which when executed by the processor, cause the processor to identify a plurality of functional blocks in a circuit, wherein each functional block includes a plurality of components, conduct one or more passes of a first optimization loop to determine candidate aspect ratios for the functional blocks based on size data associated with the components, and conduct, within the one or more passes of the first optimization loop, one or more passes of a second optimization loop to determine candidate floorplan data for the circuit based on the candidate aspect ratios.

Example 2 includes the computing system of Example 1, wherein the second optimization loop is to include a simulated annealing optimization with respect to a B*-Tree representation of the candidate floorplan data.

Example 3 includes the computing system of Example 2, wherein the simulated annealing optimization is to include a plurality of random perturbation operations.

Example 4 includes the computing system of any one of Examples 1 to 3, wherein the instructions, when executed, further cause the processor to exit the second optimization loop in response to a second time constraint.

Example 5 includes the computing system of Example 1, wherein the first optimization loop is to include a Bayesian optimization update of a surrogate model of the circuit based on the candidate floorplan data.

Example 6 includes the computing system of any one of Examples 1 to 5, wherein the instructions, when executed, further cause the processor to exit the first optimization loop in response to a first time constraint, and output a floorplan associated with a smallest surface area.

Example 7 includes at least one computer readable storage medium comprising a set of instructions, which when executed by a computing system, cause the computing system to identify a plurality of functional blocks in a circuit, wherein each functional block includes a plurality of components, conduct one or more passes of a first optimization loop to determine candidate aspect ratios for the functional blocks based on size data associated with the components, and conduct, within the one or more passes of the first optimization loop, one or more passes of a second optimization loop to determine candidate floorplan data for the circuit based on the candidate aspect ratios.

Example 8 includes the at least one computer readable storage medium of Example 7, wherein the second optimization loop is to include a simulated annealing optimization with respect to a B*-Tree representation of the candidate floorplan data.

Example 9 includes the at least one computer readable storage medium of Example 8, wherein the simulated annealing optimization is to include a plurality of random perturbation operations.

Example 10 includes the at least one computer readable storage medium of any one of Examples 7 to 9, wherein the instructions, when executed, further cause the computing system to exit the second optimization loop in response to a second time constraint.

Example 11 includes the at least one computer readable storage medium of Example 7, wherein the first optimization loop is to include a Bayesian optimization update of a surrogate model of the circuit based on the candidate floorplan data.

Example 12 includes the at least one computer readable storage medium of any one of Examples 7 to 11, wherein the instructions, when executed, further cause the computing system to exit the first optimization loop in response to a first time constraint, and output a floorplan associated with a smallest surface area.

Example 13 includes a semiconductor apparatus comprising one or more substrates, and logic coupled to the one or more substrates, wherein the logic is implemented at least partly in one or more of configurable or fixed-functionality hardware, the logic to identify a plurality of functional blocks in a circuit, wherein each functional block includes a plurality of components, conduct one or more passes of a first optimization loop to determine candidate aspect ratios for the functional blocks based on size data associated with the components, and conduct, within the one or more passes of the first optimization loop, one or more passes of a second optimization loop to determine candidate floorplan data for the circuit based on the candidate aspect ratios.

Example 14 includes the semiconductor apparatus of Example 13, wherein the second optimization loop is to include a simulated annealing optimization with respect to a B*-Tree representation of the candidate floorplan data.

Example 15 includes the semiconductor apparatus of Example 14, wherein the simulated annealing optimization is to include a plurality of random perturbation operations.

Example 16 includes the semiconductor apparatus of any one of Examples 13 to 15, wherein the logic is to exit the second optimization loop in response to a second time constraint.

Example 17 includes the semiconductor apparatus of Example 13, wherein the first optimization loop is to include a Bayesian optimization update of a surrogate model of the circuit based on the candidate floorplan data.

Example 18 includes the semiconductor apparatus of any one of Examples 13 to 17, wherein the logic is to exit the first optimization loop in response to a first time constraint, and output a floorplan associated with a smallest surface area.

Example 19 includes the semiconductor apparatus of any one of Examples 13 to 18, wherein the logic coupled to the one or more substrates includes transistor channel regions that are positioned within the one or more substrates.

Example 20 includes a method of operating a performance-enhanced computing system, the method comprising identifying a plurality of functional blocks in a circuit, wherein each functional block includes a plurality of components, conducting one or more passes of a first optimization loop to determine candidate aspect ratios for the functional blocks based on size data associated with the components, and conducting, within the one or more passes of the first optimization loop, one or more passes of a second optimization loop to determine candidate floorplan data for the circuit based on the candidate aspect ratios.

Example 21 includes the method of Example 20, wherein the second optimization loop includes a simulated annealing optimization with respect to a B*-Tree representation of the candidate floorplan data.

Example 22 includes the method of Example 21, wherein the simulated annealing optimization includes a plurality of random perturbation operations.

Example 23 includes the method of any one of Examples 20 to 22, further including exiting the second optimization loop in response to a second time constraint.

Example 24 includes the method of Example 20, wherein the first optimization loop includes a Bayesian optimization update of a surrogate model of the circuit based on the candidate floorplan data.

Example 25 includes the method of any one of Examples 20 to 24, further including exiting the first optimization loop in response to a first time constraint, and outputting a floorplan associated with a smallest surface area.

Example 26 includes an apparatus comprising means for performing the method of any one of Examples 20 to 25.

Embodiments are applicable for use with all types of semiconductor integrated circuit (“IC”) chips. Examples of these IC chips include but are not limited to processors, controllers, chipset components, programmable logic arrays (PLAs), memory chips, network chips, systems on chip (SoCs), SSD/NAND controller ASICs, and the like. In addition, in some of the drawings, signal conductor lines are represented with lines. Some may be different, to indicate more constituent signal paths, have a number label, to indicate a number of constituent signal paths, and/or have arrows at one or more ends, to indicate primary information flow direction. This, however, should not be construed in a limiting manner. Rather, such added detail may be used in connection with one or more exemplary embodiments to facilitate easier understanding of a circuit. Any represented signal lines, whether or not having additional information, may actually comprise one or more signals that may travel in multiple directions and may be implemented with any suitable type of signal scheme, e.g., digital or analog lines implemented with differential pairs, optical fiber lines, and/or single-ended lines.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A computing system comprising:
a network controller;
a processor coupled to the network controller; and
a memory coupled to the processor, the memory including a set of instructions, which when executed by the processor, cause the processor to:
identify a plurality of functional blocks in a circuit, wherein each functional block includes a plurality of components,
conduct one or more passes of a first optimization loop to determine candidate aspect ratios for the functional blocks based on size data associated with the components, and
conduct, within the one or more passes of the first optimization loop, one or more passes of a second optimization loop to determine candidate floorplan data for the circuit based on the candidate aspect ratios.

2. The computing system of claim 1, wherein the second optimization loop is to include a simulated annealing optimization with respect to a B*-Tree representation of the candidate floorplan data.

3. The computing system of claim 2, wherein the simulated annealing optimization is to include a plurality of random perturbation operations.

4. The computing system of claim 1, wherein the instructions, when executed, further cause the processor to exit the second optimization loop in response to a second time constraint.

5. The computing system of claim 1, wherein the first optimization loop is to include a Bayesian optimization update of a surrogate model of the circuit based on the candidate floorplan data.

6. The computing system of claim 1, wherein the instructions, when executed, further cause the processor to:
exit the first optimization loop in response to a first time constraint; and
output a floorplan associated with a smallest surface area.

7. At least one computer readable storage medium comprising a set of instructions, which when executed by a computing system, cause the computing system to:
identify a plurality of functional blocks in a circuit, wherein each functional block includes a plurality of components;
conduct one or more passes of a first optimization loop to determine candidate aspect ratios for the functional blocks based on size data associated with the components; and
conduct, within the one or more passes of the first optimization loop, one or more passes of a second optimization loop to determine candidate floorplan data for the circuit based on the candidate aspect ratios.

8. The at least one computer readable storage medium of claim 7, wherein the second optimization loop is to include a simulated annealing optimization with respect to a B*-Tree representation of the candidate floorplan data.

9. The at least one computer readable storage medium of claim 8, wherein the simulated annealing optimization is to include a plurality of random perturbation operations.

10. The at least one computer readable storage medium of claim 7, wherein the instructions, when executed, further cause the computing system to exit the second optimization loop in response to a second time constraint.

11. The at least one computer readable storage medium of claim 7, wherein the first optimization loop is to include a Bayesian optimization update of a surrogate model of the circuit based on the candidate floorplan data.

12. The at least one computer readable storage medium of claim 7, wherein the instructions, when executed, further cause the computing system to:
exit the first optimization loop in response to a first time constraint; and
output a floorplan associated with a smallest surface area.

13. A semiconductor apparatus comprising:
one or more substrates; and
logic coupled to the one or more substrates, wherein the logic is implemented at least partly in one or more of configurable or fixed-functionality hardware, the logic to:
identify a plurality of functional blocks in a circuit, wherein each functional block includes a plurality of components;
conduct one or more passes of a first optimization loop to determine candidate aspect ratios for the functional blocks based on size data associated with the components; and
conduct, within the one or more passes of the first optimization loop, one or more passes of a second optimization loop to determine candidate floorplan data for the circuit based on the candidate aspect ratios.

14. The semiconductor apparatus of claim 13, wherein the second optimization loop is to include a simulated annealing optimization with respect to a B*-Tree representation of the candidate floorplan data.

15. The semiconductor apparatus of claim 14, wherein the simulated annealing optimization is to include a plurality of random perturbation operations.

16. The semiconductor apparatus of claim 13, wherein the logic is to exit the second optimization loop in response to a second time constraint.

17. The semiconductor apparatus of claim 13, wherein the first optimization loop is to include a Bayesian optimization update of a surrogate model of the circuit based on the candidate floorplan data.

18. The semiconductor apparatus of claim 13, wherein the logic is to:
exit the first optimization loop in response to a first time constraint; and
output a floorplan associated with a smallest surface area.

19. The semiconductor apparatus of claim 13, wherein the logic coupled to the one or more substrates includes transistor channel regions that are positioned within the one or more substrates.

20. A method comprising:
identifying a plurality of functional blocks in a circuit, wherein each functional block includes a plurality of components;
conducting one or more passes of a first optimization loop to determine candidate aspect ratios for the functional blocks based on size data associated with the components; and
conducting, within the one or more passes of the first optimization loop, one or more passes of a second optimization loop to determine candidate floorplan data for the circuit based on the candidate aspect ratios.

21. The method of claim 20, wherein the second optimization loop includes a simulated annealing optimization with respect to a B*-Tree representation of the candidate floorplan data.

22. The method of claim 21, wherein the simulated annealing optimization includes a plurality of random perturbation operations.

23. The method of claim 20, further including exiting the second optimization loop in response to a second time constraint.

24. The method of claim 20, wherein the first optimization loop includes a Bayesian optimization update of a surrogate model of the circuit based on the candidate floorplan data.

25. The method of claim 20, further including:
exiting the first optimization loop in response to a first time constraint; and
outputting a floorplan associated with a smallest surface area.
